(19) United States
(12) Patent Application Publication
(10) Pub. No.: US 2007/0246684 A1
(43) Pub. Date: Oct. 25, 2007

(54) Film forming composition

(75) Inventor: Hidetoshi Hiraoka, Haibara-gun (JP)

Correspondence Address: SUGHRUE-265550, 2100 PENNSYLVANIA AVE. NW, WASHINGTON, DC, 20037-3213, US

(73) Assignee: FUJIFILM Corporation, Tokyo (JP)

(21) Appl. No.: 11/785,617

(22) Filed: Apr. 19, 2007

(30) Foreign Application Priority Data
Apr. 19, 2006 (JP) 2006-115821
Sep. 26, 2006 (JP) 2006-260898

(51) Int. Cl. H01M 4/88

(52) U.S. Cl. 252/182.1

(57) ABSTRACT

A film forming composition includes a compound having a cage structure and an antioxidant.

### BACKGROUND OF THE INVENTION

1. Field of the Invention

The present invention relates to a film forming composition, more specifically, a film forming composition to be used for electronic devices and excellent in film properties such as dielectric constant, mechanical strength and heat resistance. The invention also pertains to an insulating film available by the composition and an electronic device having the insulating film.

2. Description of the Related Art

In recent years, with the progress of high integration, multifunction and high performance in the field of electronic materials, circuit resistance and condenser capacity between interconnects have increased and have caused an increase in electric power consumption and delay time. Particularly, the increase in delay time becomes a large factor for reducing the signal speed of devices and generating crosstalk. Reduction of parasitic resistance and parasitic capacity are therefore required in order to reduce this delay time, thereby attaining speed-up of devices. As one of the concrete measures for reducing this parasitic capacity, an attempt has been made to cover the periphery of an interconnect with a low dielectric interlayer insulating film. The interlayer insulating film is expected to have superior heat resistance in the thin film formation step when a printed circuit board is manufactured or in post steps such as chip connection and pin attachment and also chemical resistance in the wet process. In addition, a low resistance Cu interconnect has been introduced in recent years instead of an Al interconnect, and accompanied by this, CMP (chemical mechanical polishing) has been employed commonly for planarization of the film surface. Accordingly, an insulating film having high mechanical strength and capable of withstanding this CMP step is required.

As a highly heat-resistant interlayer insulating film, polybenzoxazole, polyimide, polyarylene (ether) and the like films have been disclosed for long years. There is however a demand for the development of materials having a lower dielectric constant in order to realize a high speed device. Introduction of a hetero atom such as oxygen, nitrogen or sulfur or an aromatic hydrocarbon unit into the molecule of a polymer similar to the above-described materials, however, increases a dielectric constant owing to high molar polarization, causes a time-dependent increase in the dielectric constant owing to moisture absorption, or causes a trouble impairing reliability of an electronic device so that these materials need improvement.

A polymer composed of a saturated hydrocarbon has advantageously a lower dielectric constant because it has smaller molar polarization than a polymer composed of a hetero-atom-containing unit or aromatic hydrocarbon unit. For example, a hydrocarbon such as polyethylene having high flexibility has however only insufficient heat resistance and therefore cannot be used for electronic devices.

Polymers having a saturated hydrocarbon having a rigid cage structure such as adamantane or diamantane introduced in their molecules are disclosed in JP-A-2000-100808, JP-A-2001-2899 and JP-A-2001-2900 (the term “JP-A” as used herein means an “unexamined published Japanese patent application”). Adamantane or diamantane is a preferable unit because it has a diamondoid structure and exhibits high heat resistance and low dielectric constant. The solubility of these polymers in a solvent is however too low to form a thin film or the dielectric constant of them inevitably increases owing to the influence of a linking group of the cage structure. Their improvement is therefore required.

### SUMMARY OF THE INVENTION

The invention relates to a film forming composition for overcoming the above-described problems. More specifically, the invention relates to a film forming composition used for electronic devices and excellent in film properties such as dielectric constant and heat resistance. The invention further pertains to an insulating film obtained by using the composition and an electronic device having the insulating film. An “insulating film” is also referred to as a “dielectric film” or a “dielectric insulating film”, and these terms are not substantially distinguished.

The present inventors have found that the above-described problems can be overcome by the following constitutions <1> to <12>.

<1> A film forming composition comprising:

a compound having a cage structure; and

an antioxidant.

<2> The film forming composition as described in <1>, wherein the antioxidant is a phenolic antioxidant.

<3> The film forming composition as described in <1>, wherein the antioxidant is a hindered amine antioxidant.

<4> The film forming composition as described in <1>,

wherein the compound having the cage structure is a polymer of a monomer having a cage structure.

<5> The film forming composition as described in <4>,
wherein the monomer having the cage structure has a carbon-carbon double bond or a carbon-carbon triple bond.

<6> The film forming composition as described in <I>,

wherein the cage structure is selected from the group consisting of adamantane, biadamantane, diamantane, triamantane and tetramantane.

<7> The film forming composition as described in <4>,

wherein the monomer having the cage structure is a compound represented by any one of formulas (I) to (VI):

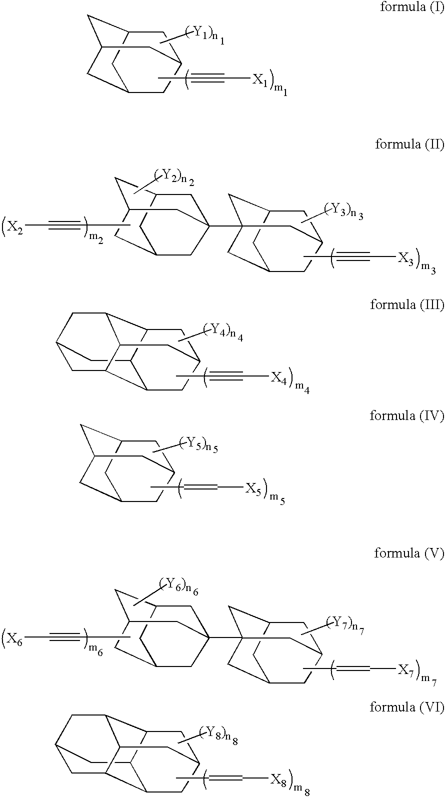

wherein X₁ to X₈ each independently represents an atom or group selected from the group consisting of a hydrogen atom, an alkyl group, an alkenyl group, an alkynyl group, an aryl group, a silyl group, an acyl group, an alkoxycarbonyl group and a carbamoyl group;

Y₁ to Y₈ each independently represents an atom or group selected from the group consisting of a halogen atom, an alkyl group, an aryl group and a silyl group;

m₁ and m₅ each independently represents an integer of from 1 to 16;

n₁ and n₅ each independently represents an integer of from 0 to 15;

m₂, m₃, m₆ and m₇ each independently represents an integer of from 1 to 15;

n₂, n₃, n₆ and n₇ each independently represents an integer of from 0 to 14;

m₄ and m₈ each independently represents an integer of from 1 to 20; and

n₄ and n₈ each independently represents an integer of from 0 to 19.

<8> The film forming composition as described in <1>,

wherein the compound having the cage structure is obtained by polymerizing the monomer having the cage structure in the presence of a transition metal catalyst or a radical initiator.

<9> The film forming composition as described in <1>,

wherein the compound having the cage structure has a solubility at 25° C. of 3 mass % (in this specification, mass ration is equal to weight ration) or greater in cyclohexanone or anisole.

<10> The film forming composition as described in <1>, further comprising an organic solvent.

<11> An insulating film formed by using the film forming composition as described in <1>.

<12> An electronic device comprising the insulating film as described in <11>.

### DETAILED DESCRIPTION OF THE INVENTION

The present invention will hereinafter be described specifically.

In the description herein, groups (atomic groups) without description on whether they are substituted or unsubstituted embrace both unsubstituted and substituted ones. For example, “alkyl groups” embrace not only alkyl groups (unsubstituted alkyl groups) having no substituent but also alkyl groups (substituted alkyl groups) having a substituent.

The film forming composition of the invention is characterized in that it contains a compound having a cage structure and an antioxidant.

When an antioxidant is contained, deterioration in properties such as dielectric constant due to oxidation of a film caused in each step such as photolithography or CMP.

### <Antioxidant>

Examples of the antioxidant usable in the invention include those described in Plastics Additives New Edition: Fundamentals and Application, published by Taiseisha, Antioxidant Handbook published by Taiseisha, and Plastics Additive Note published by Kogyo Chosakai Publishing.

The antioxidant usable in the invention has a mass average molecular weight of from 100 to 50000, more preferably from 150 to 30000, especially preferably from 200 to 20000.

As the antioxidant, phenolic antioxidants, hindered amine antioxidants, sulfur antioxidants and phosphorus antioxidants are preferred, of which the phenolic antioxidants and hindered amine antioxidants are especially preferred.

Phenolic antioxidants having, in the molecule thereof, at least one below-described structure are preferred.

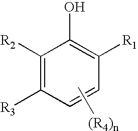

In the above formula, R₁, R₂ and R₃ each independently represents a hydrogen atom, methyl group, t-butyl group or linking group, and at least one of R₁, R₂ and R₃ is a t-butyl group and at most one of the remaining two is a hydrogen atom. R₁ to R₃ may link a plurality of the above-described structures while serving as a linking group (preferably, divalent to tetravalent).

R₄ represents a hydrogen atom or a substituent. Examples of the substituent include halogen atoms (fluorine and chlorine), alkyl groups (C₁₋₂₀ alkyl groups such as methyl, ethyl, propyl, isopropyl, butyl, 2-butyl, hexyl, octyl, 2-ethylhexyl, cyclohexyl, dodecyl, tetradecyl and hexadecyl), aryl groups (C₂₋₂₀ aryl groups such as phenyl and 1-naphthyl), heterocyclic groups (C₁₋₂₀ heterocyclic groups such as 4-piperidinyl, 2-furyl and 2-pyranyl), alkoxy groups (C₁₋₂₀ alkoxy groups such as methoxy, ethoxy, propoxy, butoxy, 2-butoxy, 2-ethylhexyloxy, dodecyloxy and cyclohexyloxy), aryloxy groups (C₆₋₂₀ aryloxy groups such as phenoxy an 1-naphthoxy), acyloxy groups (C₂₋₂₀ acyloxy groups such as acetoxy, butoxy and benzoyloxy), alkoxycarbonyloxy groups (C₂₋₂₀ alkoxycarbonyloxy groups such as methoxycarbonyloxy and ethoxycarbonyloxy), amino groups (C₀₋₂₀ amino groups such as amino, methylamino, 2-ethylhexylamino, tetradecylamino and cyclohexylamino), arylamino groups (C₆₋₂₀ arylamino groups such as anilino and 1-naphthylamino), acylamino groups (C₂₋₂₀ acylamino groups such as acetylamino, butanoylamino and benzoylamino), alkoxycarbonylamino groups (C₂₋₂₀ alkoxycarbonylamino groups such as methoxycarbonylamino, ethoxycarbonylamino and cyclohexyloxycarbonylamino), aminocarbonylamino groups (C₁₋₂₀ aminocarbonylamino groups such as ureido and N,N-dimethylaminocarbonylamino), alkylthio groups (C₁₋₂₀ alkylthio groups such as methylthio, ethylthio, butylthio, octylthio, 2-ethylhexylthio, dodecylthio and cyclohexylthio), arylthio groups (C₆₋₂₀ arylthio groups such as phenylthio and 1-naphthylthio) and alkoxycarbonyl groups (C₂₋₂₀ alkoxycarbonyl groups such as methoxycarbonyl, ethoxycarbonyl, butoxycarbonyl, cyclohexyloxycarbonyl and dodecyloxycarbonyl). Of these, preferred substituents are alkyl groups and alkoxy groups, with alkyl groups being more preferred. The substituent may link, as a linking group (preferably, bivalent to tetravalent) a plurality of the above-described structures. R₄ is preferably a C₁₋₃₀ group and it may have, there in, an alkylene, —COO—, —OCO—, —O— or isocyanurate structure. “n” stands for an integer of from 0 to 3, preferably 1.

Specific examples of the phenolic antioxidants include 2,6-di-t-butyl-p-cresol, 4,4′-butylidenebis-(6-t-butyl-3-methylphenol), 2,2′-methylenebis-(4-methyl-6-t-butylphenol), 2,2′-methylenebis-(4-ethyl-6-t-butylphenol), 2,6-di-t-butyl-4-ethylphenol, 1,1,3-tris(2-methyl-4-hydroxy-5-t-butylphenyl)butane, n-octadecyl-3-(3,5-di-t-butyl-4-hydroxyphenyl)propionate, tetrakis[methylene-3-(3,5-di-t-butyl-4-hydroxyphenyl)propionate]methane, triethyleneglycolbis[3-(3-t-butyl-4-hydroxy-5-methylphenyl)propionate], tris(3,5-di-t-butyl-4-hydroxybenzyl)isocyanurate, dilaurylthiodipropionate, distearylthiodipropionate, dimyristylthiodipropionate, and 1,1,3-tris(2-methyl-4-hydroxy-5-t-butylphenol)butane.

The hindered amine antioxidants preferably have, in the molecule thereof, at least one below-described structure.

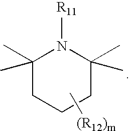

wherein, R₁₁ represents a hydrogen atom or a substituent, preferably hydrogen or a methyl group. R₁₂ represents a hydrogen atom or a substituent. Substituents given by the above-described R₄ are preferred as the substituent, of which alkyl groups, alkoxy groups, acyloxy groups, amino groups and acylamino groups are preferred, with acyloxy groups and amino groups being more preferred. The substituent may link a plurality of the hindered amine structures as a linking group having two or more valences. As the linking group, alkylene groups, —COO—, —OCO—, —O—, and isocyanurate structure and combination thereof are preferred. R₁₂ is preferably a C₁₋₃₀ group which may contain a nitrogen atom. The hindered amine antioxidants may be a polymer containing, in repeating units thereof, the above-described structure.

Specific examples of the hindered amine antioxidant include bis-(2,2,6,6-tetramethyl-4-piperidinyl)sebacate, bis-(N-methyl-2,2,6,6-tetramethyl-4-piperidinyl)sebacate, bis-(1,2,2,6,6-pentamethyl-4-piperidinyl)-2-(3,5-di-t-butyl-4-hydroxy-benzyl)-2-n-butylmalonate, tetrakis(2,2,6,6-tetramethyl-4-piperidinyl)-1,2,3,4-tbutanetetracarboxylate, tetrakis(1,2,2,6,6-pentamethyl-4-piperidinyl)-1,2,3,4,-butanetetracarboxylate.

The composition of the present invention may contain a sulfur antioxidant having a structure represented by the following formula:

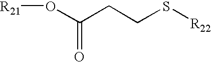

wherein, R₂₁ represents a hydrogen atom or a substituent, R₂₂ represents a hydrogen atom or a substituent and the substituent may link, as a linking group, a plurality of the above-described structures. Examples of the substituent include those which are exemplified as the substituent represented by R₄ and at the same time, coupled via a carbon atom. Alkyl groups are preferred. The substituent may have therein —COO—, —OCO—, or —O— and alkyl groups having —COO—, —OCO—or —O— are preferred.

Examples of the sulfur antioxidant include ditridecylthiodipropionate and pentaerythritoltetrakis(3-laurylthiopropionate).

The composition of the present invention may contain a phosphorus antioxidant having a structure represented by the following formula:

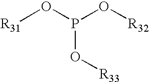

wherein, R₃₁, R₃₂ and R₃₃ each independently represents a substituent. Examples of the substituent include those given as the substituent represented by R₄ and at the same time, coupled via a carbon atom. Preferred examples of the substituent include alkyl groups and aryl groups. The alkyl groups may contain an ether bond. R₃₁, R₃₂ and R₃₃ may link a plurality of the above-described structures as a linking group. R₃₁ and R₃₂, R₃₁ and R₃₃ or R₃₂ and R₃₃ may be coupled to form a ring.

Examples of the phosphorus antioxidant include trisnonylphenylphosphite, tris(2,4-di-t-butylphenyl)phosphite, distearylpentaerythritoldiphosphite, bis(2,4-di-t-butylphenyl)pentaerythritolphosphite, 2,2-methylenebis(4,6-di-t-butylphenyl)octylphosphite, and tetrakis(2,4-di-t-butylphenyl)-4,4-biphenylene-di-phosphonite.

These antioxidants may be commercially available or can be synthesized in a commonly employed process. Examples of the commercially available antioxidants include “ADK STAB Series” (product of ADEKA), “Irganox Series” (products of Ciba Specialty Chemicals), “Sumilizer Series” (products of Sumitomo Chemical), “Antage Series” (products of Kawaguchi Chemical Industry) and “Yoshinox Series” (products of API corporation).

In the present invention, the above-described antioxidants may be used either singly or in combination.

The antioxidants usable in the present invention have a molecular weight of preferably from 100 to 50000, more preferably from 150 to 30000, especially preferably from 200 to 20000. Within this range, the antioxidant can remain in the film without evaporation or sublimation during baking and filtration property and solvent solubility can be kept without deterioration. When the antioxidant is a polymer, the above-described molecular weight means a weight-average molecular weight.

The amount of the antioxidant in the invention is preferably from 0.001 to 50 mass %, more preferably from 0.005 to 10 mass %, especially preferably from 0.01 to 5 mass % based on 100 mass % of the polymer.

### <Compound Having a Cage Structure>

The term “cage structure” as used herein means a molecule in which a plurality of rings formed of covalent-bonded atoms define the capacity of the structure and in which all points existing inside the capacity cannot leave the capacity without passing through the rings. For example, an adamantane structure may be considered as the cage structure. Contrary to this, a single crosslink-having cyclic structure such as norbomane (bicyclo[2,2,1]heptane) cannot be considered as the cage structure because the ring of the single-crosslinked cyclic compound does not define the capacity of the compound.

The cage structure of the invention may contain either a saturated bond or unsaturated bond and may contain a hetero atom such as oxygen, nitrogen or sulfur. A saturated hydrocarbon is however preferred from the viewpoint of a low dielectric constant.

Preferred examples of the cage structure of the invention include adamantane, biadamantane, diamantane, triamantane, tetramantane and dodecahedrane, of which adamantane, biadamantane and diamantane are more preferred. Of these, biadamantane and diamantane are especially preferred, because they have a low dielectric constant.

The cage structure according to the invention may have one or more substituents. Examples of the substituents include halogen atoms (fluorine, chlorine, bromine and iodine), linear, branched or cyclic C₁₋₁₀ alkyl groups (such as methyl, t-butyl, cyclopentyl and cyclohexyl), C₂₋₁₀ alkenyl groups (such as vinyl and propenyl), C₂₋₁₀ alkynyl groups (such as ethynyl and phenylethynyl), C₆₋₂₀ aryl groups (such as phenyl, 1-naphthyl and 2-naphthyl), C₂₋₁₀ acyl groups (such as benzoyl), C₂₋₁₀ alkoxycarbonyl groups (such as methoxycarbonyl), C₁₋₁₀ carbamoyl groups (such as N,N-diethylcarbamoyl), C₆₋₂₀ aryloxy groups (such as phenoxy), C₆₋₂₀ arylsulfonyl groups (such as phenylsulfonyl), nitro group, cyano group, and silyl groups (such as triethoxysilyl, methyldiethoxysilyl and trivinylsilyl).

In the invention, the cage structure is preferably divalent to tetravalent. In this case, a group to be coupled to the cage structure may be a substituent having a valence of one or more or a linking group having a valence of two or more. The cage structure has more preferably divalent or trivalent, especially preferably divalent. The compound having a cage structure to be used in the invention preferably contains a polymer of a monomer having a cage structure. The monomer having a cage structure has preferably a polymerizable carbon-carbon double bond or polymerizable carbon-carbon triple bond. As the polymerizable carbon-carbon double bond, alkenyl groups are preferred, with a vinyl group being especially preferred. As the polymerizable carbon-carbon triple bond, alkynyl groups are preferred, with an ethynyl group being especially preferred.

The term “monomer” as used herein means a monomer which will be a dimer or higher polymer by the polymerization of it. The polymer may be either a homopolymer or copolymer. Examples of the polymer include a homopolymer of the monomer having a cage structure, a copolymer between the monomer having a cage structure and another polymerizable compound, a copolymer of two or more monomers having a cage structure, and a copolymer between at least two monomers having a cage structure and at least one another polymerizable compound.

The compound having a cage structure which is used in the invention is preferably a polymer of a compound (monomer) represented by any one of the below-described formulas (I) to (VI):

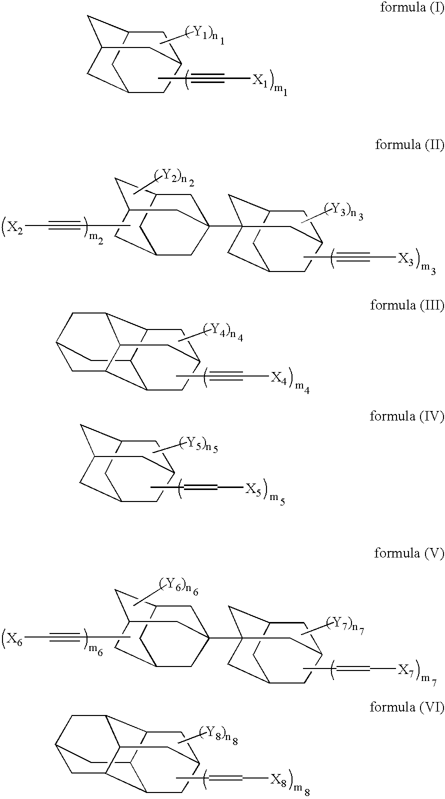

In the formulas (I) to (VI),

X₁ to X₈ each independently represents a hydrogen atom, an alkyl group (preferably a C₁₋₁₀ alkyl group such as methyl, ethyl, propyl, isopropyl, t-butyl, hexyl or 2-ethylhexyl), an alkenyl group (preferably a C₂₋₁₀ alkenyl group such as vinyl, allyl or 2-buten-1-yl), an alkynyl group (preferably C₂₋₁₀ alkynyl groups such as ethynyl, propargyl or 1-butyn-4-yl), an aryl group (preferably a C₆₋₂₀ aryl group such as phenyl, p-tolyl or 1-naphthyl), a silyl group (preferably a C₀₋₂₀ silyl group such as trimethylsilyl, t-butyldimethylsilyl, diethoxymethylsilyl or dimethoxymethylsilyl), an acyl group (preferably a C₂₋₁₀ acyl group such as acetyl, isobutyryl or benzoyl), an alkoxycarbonyl group (preferably a C₂₋₁₀ alkoxycarbonyl group such as methoxycarbonyl or ethoxycarbonyl), or a carbamoyl group (preferably a C₁₋₂₀ carbamoyl group such as carbamoyl, N-methylcarbamoyl or N,N-diethylcarbamoyl), of which hydrogen atom, C₁₋₁₀ alkyl group, C₆₋₂₀ aryl group, C₀₋₂₀ silyl group, C₂₋₂₀ acyl group, C₂₋₁₀ alkoxycarbonyl group, or C₁₋₂₀ carbamoyl group is preferred; hydrogen atom or C₆₋₂₀ aryl group is more preferred; and hydrogen atom is especially preferred.

Y₁ to Y₈ each independently represents a halogen atom (fluorine, chlorine, bromine or the like), an alkyl group (preferably C₁₋₁₀), an aryl group (preferably C₆₋₂₀) or a silyl group (preferably C₀₋₂₀), of which a C₁₋₁₀ alkyl group or C₆₋₂₀ aryl group which may have a substituent is more preferred and an alkyl (methyl or the like) group is especially preferred.

X₁ to X₈ and Y₁ to Y₈ may each be substituted by another substituent. Examples of the substituent include halogen atoms (fluorine, chlorine, bromine and iodine), linear, branched or cyclic alkyl groups (C_{1-20,} preferably C₁₋₁₀ alkyl groups such as methyl, t-butyl, cyclopentyl, cyclohexyl, adamantyl, biadamantyl, and diamantyl), alkynyl groups (C₂₋₁₀ alkynyl groups such as ethynyl and phenylethynyl), aryl groups (C₆₋₁₀ aryl groups such as phenyl, 1-naphthyl and 2-naphthyl), acyl groups (C₁₋₁₀ acyl groups such as acetyl and benzoyl), aryloxy groups (C₆₋₁₀ aryloxy groups such as phenoxy), arylsulfonyl groups (C₆₋₁₀ arylsulfonyl groups such as phenylsulfonyl), nitro group, cyano group, silyl groups (C₁₋₁₀ silyl groups such as triethoxysilyl, methyldiethoxysilyl and trivinylsilyl), alkoxycarbonyl groups (C₂₋₁₀ alkoxycarbonyl groups such as methoxycarbonyl), and carbamoyl groups (C₁₋₁₀ carbamoyl groups such as carbamoyl and N,N-dimethylcarbamoyl).

In the above formulas, m₁ and m₅ each independently represents an integer of from 1 to 16, preferably an integer of from 1 to 4, more preferably an integer of from 1 to 3, especially preferably 2;

n₁ and n₅ each independently represents an integer of from 0 to 15; preferably an integer of from 0 to 4, more preferably 0 or 1, especially preferably 0;

m₂, m₃, m₆ and m₇ each independently represents an integer of from 1 to 15; preferably an integer of from 1 to 4, more preferably 1 to 3, especially preferably 2;

n₂, n₃, n₆ and n₇ each independently represents an integer of from 0 to 14; preferably an integer of from 0 to 4, more preferably 0 or 1, especially preferably 0;

m₄ and m₈ each independently represents an integer of from 1 to 20; preferably an integer of from 1 to 4, more preferably 1 to 3, especially preferably 2; and

n₄ and n₈ each independently represents an integer of from 0 to 19, preferably an integer of from 0 to 4, more preferably 0 or 1, especially preferably 0.

The monomer having a cage structure which is used in the invention is preferably a compound represented by the above-described formula (II), (III), (V) or (VI), more preferably a compound represented by the formula (II) or (III), especially preferably a compound represented by the formula (III).

Specific examples of the monomer having a cage structure and usable in the invention will next be described, but the present invention is not limited thereto.

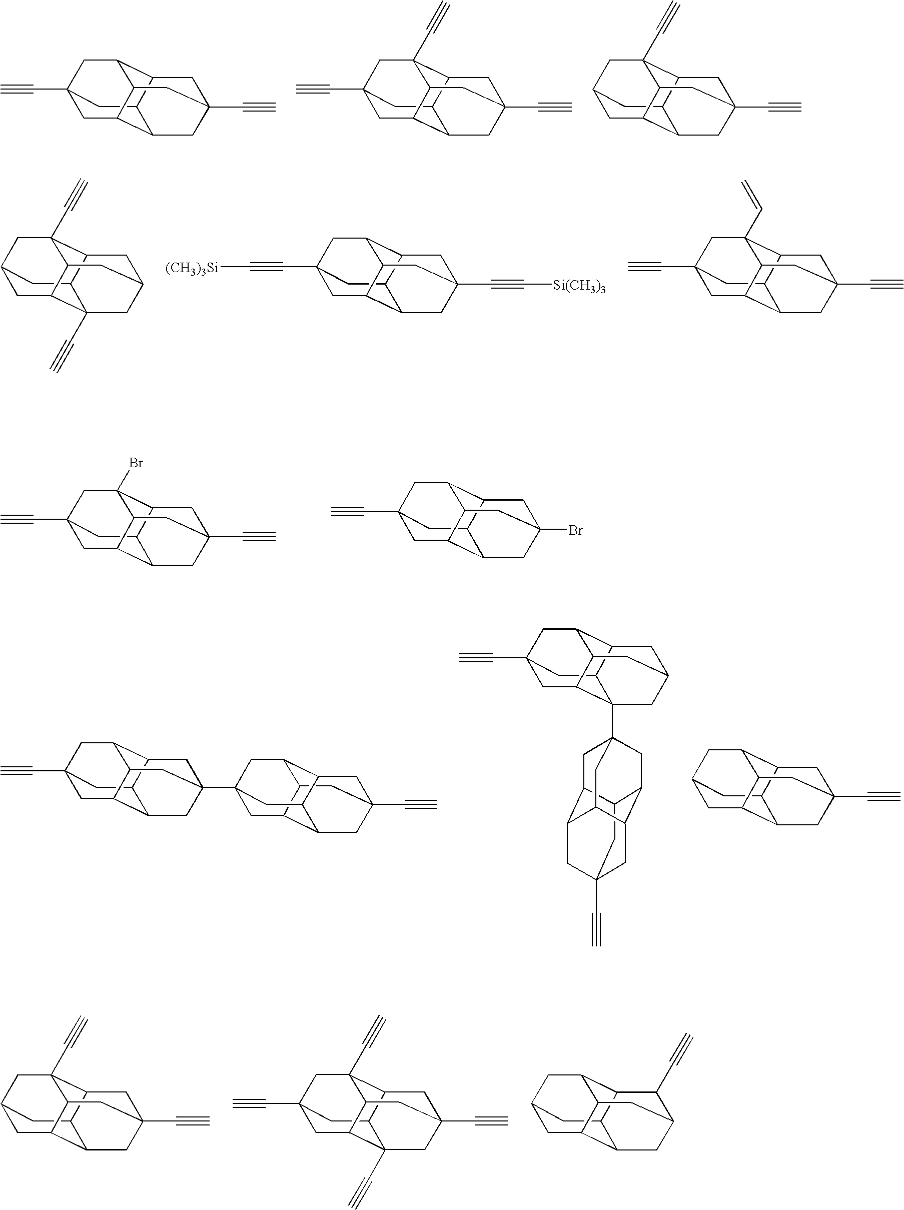

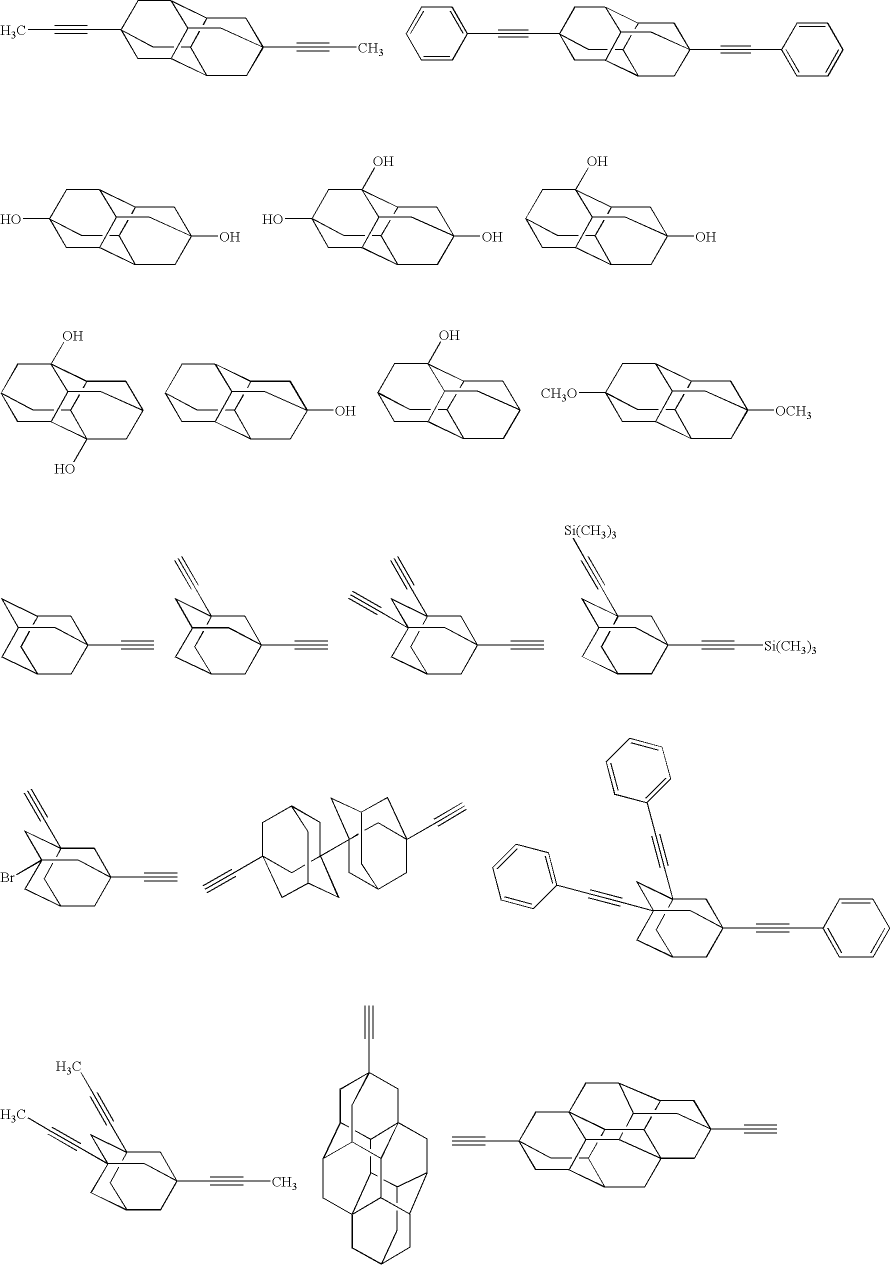

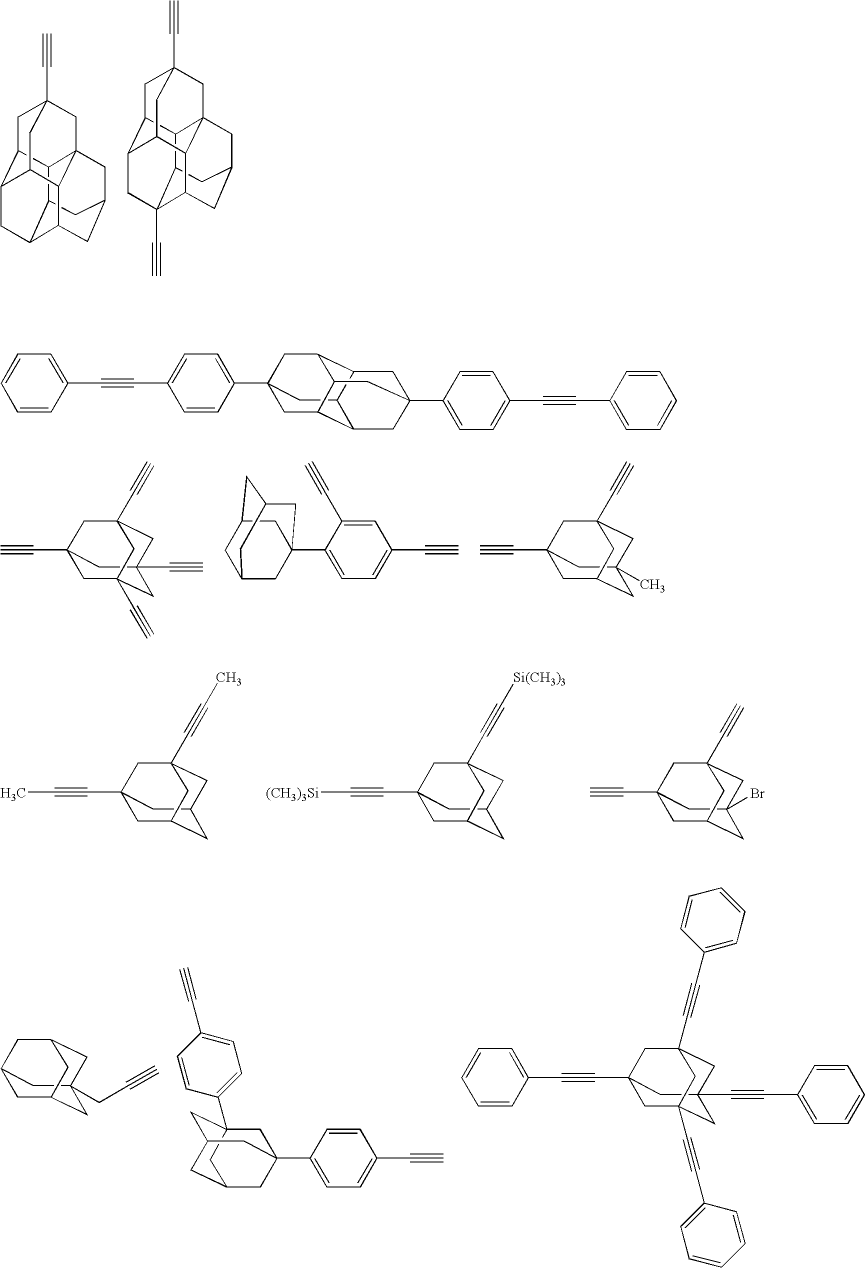

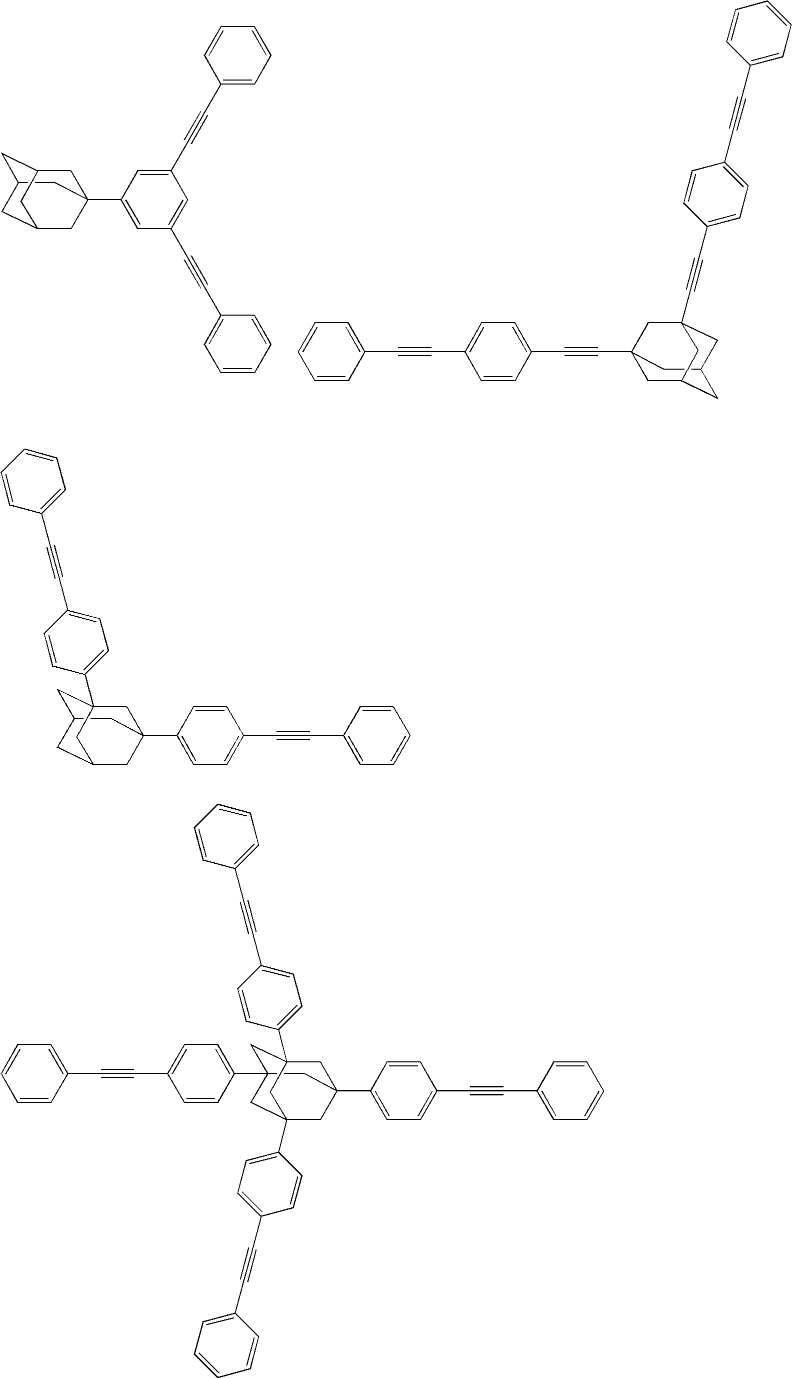

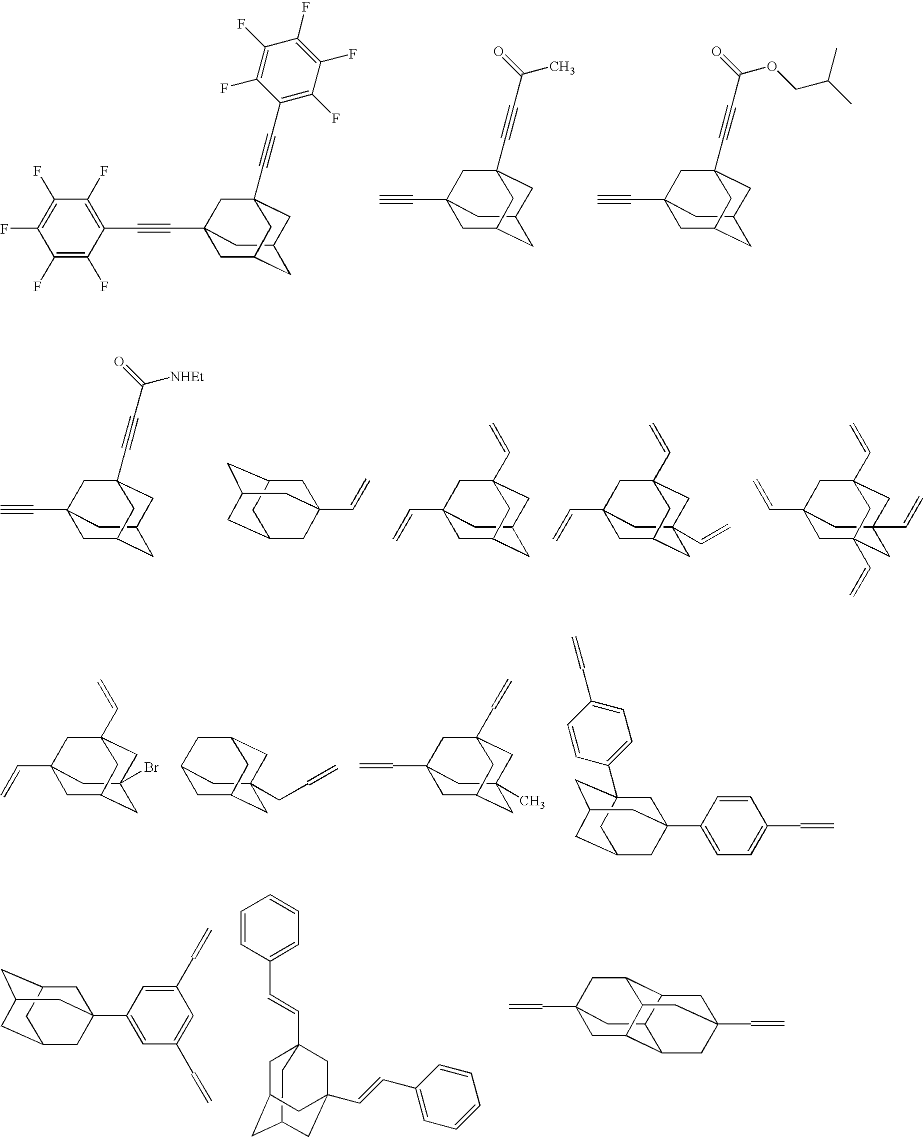

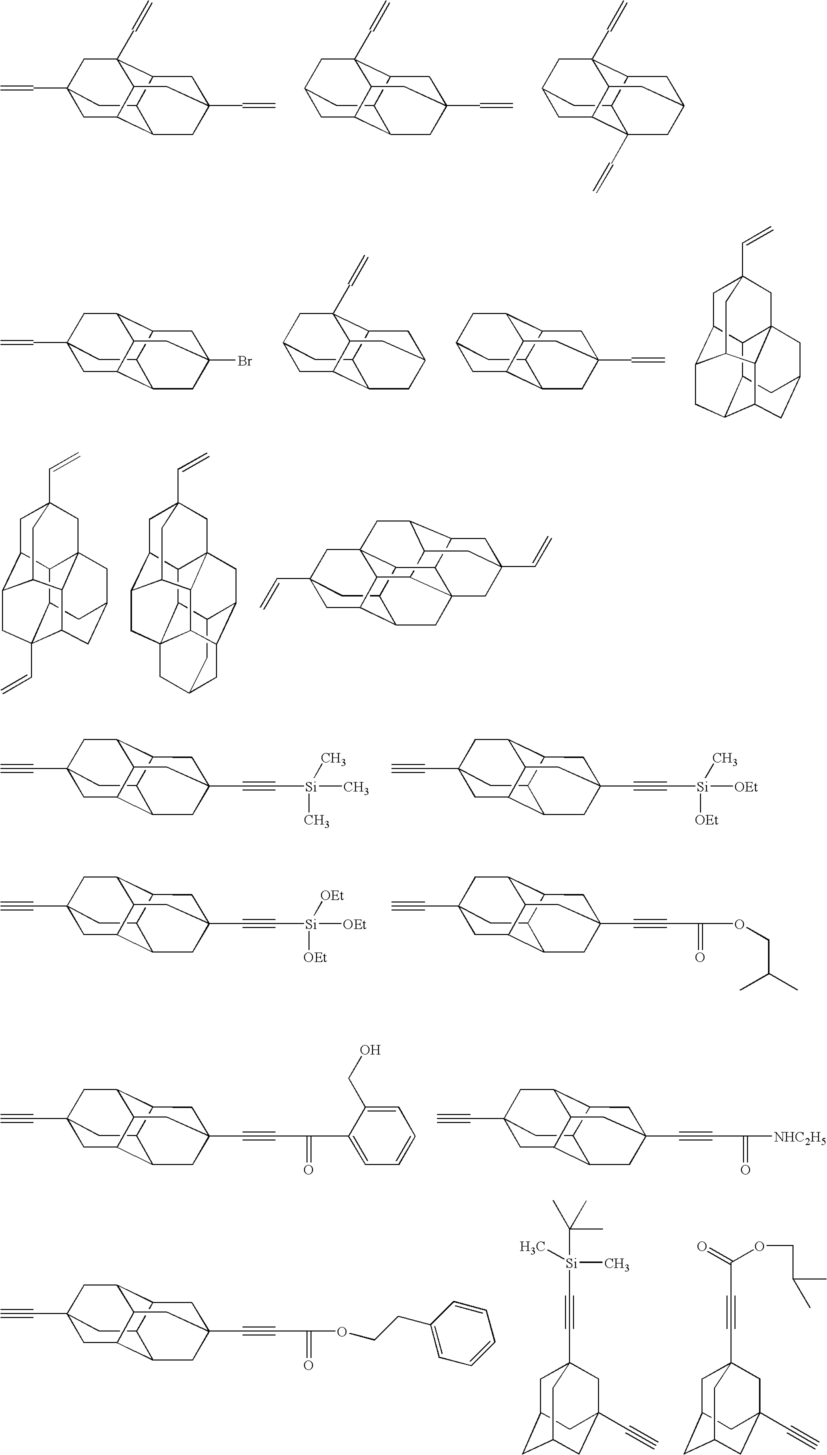

Of the monomers having a cage structure which are used in the invention, a monomer having a carbon-carbon triple bond, for example, can be synthesized by using, for example, commercially available diamantane as a raw material, reacting it with bromine in the presence or absence of an aluminum bromide catalyst to introduce a bromine atom into a desired position, causing Friedel-Crafts reaction between the resulting compound with vinyl bromine in the presence of a Lewis acid such as aluminum bromide, aluminum chloride or iron chloride to introduce a 2,2-dibromoethyl group, and then converting it into an ethynyl group by the HBr elimination using a strong base. More specifically, it can be synthesized in accordance with the process as described in Macromolecules, 24, 5266-5268(1991) and 28, 5554-5560(1995), Journal of Organic Chemistry, 39, 2995-3003(1974) and the like. The monomer having a carbon-carbon double bond is easily available by reducing an ethynyl-containing monomer with diisobutyl aluminum hydride (DIBAL-H) or the like.

An alkyl group or silyl group may be introduced by making the hydrogen atom of the terminal acetylene group anionic by butyl lithium or the like and then reacting the resulting compound with an alkyl halide or silyl halide.

The polymerization reaction of the monomer starts by a polymerizable group substituted for the monomer. The term “polymerizable group” as used herein means a reactive substituent which polymerizes the monomer. Although the polymerization reaction is not limited, examples include radical polymerization, cationic polymerization, anionic polymerization, ring-opening polymerization, polycondensation, polyaddition, addition condensation and polymerization using a transition metal catalyst.

The polymerization reaction of the monomer in the invention is preferably carried out in the presence of a non-metallic polymerization initiator. For example, a monomer having a polymerizable carbon-carbon double bond or carbon-carbon triple bond can be polymerized in the presence of a polymerization initiator showing activity while generating free radicals such as carbon radicals or oxygen radicals by heating.

As the polymerization initiator, organic peroxides and organic azo compounds are preferred, of which organic peroxides are especially preferred.

Preferred examples of the organic peroxides include ketone peroxides such as “PERHEXA H”, peroxyketals such as “PERHEXA TMH”, hydroperoxides such as “PERBUTYL H-69”, dialkylperoxides such as “PERCUMYL D”, “PERBUTYL C” and “PERBUTYL D”, diacyl peroxides such as “NYPER BW”, peroxy esters such as “PERBUTYL Z” and “PERBUTYL L”, and peroxy dicarbonates such as “PEROYL TCP”, (each, trade name; commercially available from NOF Corporation), diisobutyryl peroxide, cumylperoxyneodecanoate, di-n-propylperoxydicarbonate, diisopropylperoxydicarbonate, di-sec-butylperoxydicarbonate, 1,1,3,3-tetramethylbutylperoxyneodecanoate, di(4-t-butylchlorohexyl)peroxydicarbonate, di(2-ethylhexyl)peroxydicarbonate, t-hexylperoxyneodecanoate, t-butylperoxyneodecanoate, t-butylperoxyneoheptanoate, t-hexylperoxypivalate, t-butylperoxypivalate, di(3,5,5-trimethylhexanoyl)peroxide, dilauroyl peroxide, 1,1,3,3-tetramethylbutylperoxy-2-ethylhexanoate, disuccinic acid peroxide, 2,5-dimethyl-2,5-di(2-ethylhexanoylperoxy)hexane, t-hexylperoxy-2-ethylhexanoate, di(4-methylbenzoyl)peroxide, t-butylperoxy-2-ethylhexanoate, di(3-methylbenzoyl)peroxide, benzoyl(3-methylbenzoyl)peroxide, dibenzoyl peroxide, 1,1-di(t-butylperoxy)-2-methylcyclohexane, 1,1-di(t-hexylperoxy)-3,3,5-trimethylcyclohexane, 1,1-di(t-hexylperoxy)cyclohexane, 1,1-di(t-butylperoxy)cyclohexane, 2,2-di(4,4-di-(t-butylperoxy)cyclohexyl)propane, t-hexylperoxyisopropyl monocarbonate, t-butylperoxymaleic acid, t-butylperoxy-3,5,5-trimethylhexanoate, t-butylperoxylaurate, t-butylperoxyisopropylmonocarbonate, t-butylperoxy-2-ethylhexylmonocarbonate, t-hexylperoxybenzoate, 2,5-dimethyl-2,5-di(benzoylperoxy)hexane, t-butylperoxyacetate, 2,2-di-(t-butylperoxy)butane, t-butylperoxybenzoate, n-butyl-4,4-di-t-butylperoxyvalerate, di(2-t-butylperoxyisopropyl)benzene, dicumyl peroxide, di-t-hexyl peroxide, 2,5-dimethyl-2,5-di(t-butylperoxy)hexane, t-butylcumyl peroxide, di-t-butyl peroxide, p-methane hydroperoxide, 2,5-dimethyl-2,5-di(t-butylperoxy)hexine-3, diisopropylbenzene hydroperoxide, 1,1,3,3-tetramethylbutyl hydroperoxide, cumene hydroperoxide, t-butyl hydroperoxide, 2,3-dimethyl-2,3-diphenylbutane, 2,4-dichlorobenzoyl peroxide, o-chlorobenzoyl peroxide, p-chlorobenzoyl peroxide, tris-(t-butylperoxy)triazine, 2,4,4-trimethylpentylperoxyneodecanoate, α-cumylperoxyneodecanoate, t-amylperoxy-2-ethylhexanoate, t-butylperoxyisobutyrate, di-t-butylperoxyhexahydroterephthalate, di-t-butylperoxytrimethyladipate, di-3-methoxybutylperoxydicarbonate, di-isopropylperoxydicarbonate, t-butylperoxyisopropylcarbonate, 1,6-bis(t-butylperoxycarbonyloxy)hexane, diethylene glycol bis(t-butylperoxycarbonate) and t-hexylperoxyneodecanoate.

Examples of the organic azo compound include azonitrile compounds such as “V-30”, “V-40”, “V-59”, “V-60”, “V-65” and “V-70”, azoamide compounds such as “VA-080”, “VA-085”, “VA-086”, “VF-096”, “VAm-110” and “VAm-111”, cyclic azoamidine compounds such as “VA-044” and “VA-061”, and azoamidine compounds such as “V-50” and VA-057” (each, trade name; commercially available from Wako Pure Chemical Industries), 2,2-azobis(4-methoxy-2,4-dimethylvaleronitrile), 2,2-azobis(2,4-dimethylvaleronitrile), 2,2-azobis(2-methylpropionitrile), 2,2-azobis(2,4-dimethylbutyronitrile), 1,1-azobis(cyclohexane-1-carbonitrile), 1-[(1-cyano-1-methylethyl)azo]formamide, 2,2-azobis {2-methyl-N-[1,1-bis(hydroxymethyl)-2-hydroxyethyl]propionamide}, 2,2-azobis[2-methyl-N-(2-hydroxybutyl)propionamide], 2,2-azobis[N-(2-propenyl)-2-methylpropionamide], 2,2-azobis(N-butyl-2-methylpropionamide), 2,2-azobis(N-cyclohexyl-2-methylpropionamide), 2,2-azobis[2-(2-imidazolin-2-yl)propane]dihydrochloride, 2,2-azobis[2-(2-imidazolin-2-yl)]propane]disulfate dihydrate, 2,2-azobis{2-[1-(2-hydroxyethyl)-2-imidazolin-2-yl]propane}dihydrochloride, 2,2-azobis[2-[2-imidazolin-2-yl]propane], 2,2-azobis(1-imino-1-pyrrolidino-2-methylpropane)dihydrochloride, 2,2-azobis(2-methylpropionamidine)dihydrochloride, 2,2-azobis[N-(2-carboxyethyl)-2-methylpropionamidine]tetrahydrate, dimethyl-2,2-azobis(2-methylpropionate), 4,4-azobis(4-cyanovaleric acid) and 2,2-azobis(2,4,4-trimethylpentane).

In the invention, these polymerization initiators may be used either singly or in combination.

The amount of the polymerization initiator in the invention is preferably from 0.001 to 2 moles, more preferably from 0.01 to 1 mole, especially preferably from 0.05 to 0.5 mole, per mole of the monomer.

In the invention, the polymerization reaction of a monomer may be effected in the presence of a transition metal catalyst. For example, it is preferred to carry out polymerization of a monomer having a polymerizable carbon-carbon double bond or carbon-carbon triple bond, for example, in the presence of a Pd catalyst such as Pd(PPh₃)₄ or Pd(OAc)₂, a Ziegler-Natta catalyst, an Ni catalyst such as nickel acetyl acetonate, a W catalyst such as WCl₆, an Mo catalyst such as MoCl₅, a Ta catalyst such as TaCl₅, an Nb catalyst such as NbCl₅, an Rh catalyst or a Pt catalyst.

In the invention, these transition metal catalysts may be used either singly or in combination.

In the invention, the amount of the transition metal catalyst is preferably from 0.001 to 2 moles, more preferably from 0.01 to 1 mole, especially preferably from 0.05 to 0.5 mole per mole of the monomer.

The cage structure in the invention may have been substituted as a pendant group in the polymer or may have become a portion of the polymer main chain, but latter is preferred. When the cage structure has become a portion of the polymer main chain, the polymer chain is broken by the removal of the cage compound from the polymer. In this state, the cage structure may be linked directly via a single bond or by an appropriate divalent linking group. Example of the linking group include —C(R¹¹)(R¹²)—, —C(R¹³)═C(R¹⁴)—, —C≡C—, arylene group, —CO—, —O—, —SO₂—, —N(R¹⁵)—, and —Si(R¹⁶)(R¹⁷)—, and combination thereof In these groups, R¹¹ to R¹⁷ each independently represents a hydrogen atom, an alkyl group, an alkenyl group, an alkynyl group or an aryl group. These linking groups may be substituted by a substituent and as the substituent, the above-described ones are preferred.

Of these, —C(R¹¹)(R¹²)—, —CH═CH—, —C≡C—, arylene group, —O— and —Si(R¹⁶)(R¹⁷)—, and combination thereof are more preferred, with —C(R¹¹)(R¹²)— and —CH≡CH— being especially preferred in consideration of a low dielectric constant.

The compound of the invention having a cage structure may be either a low molecular compound or high molecular compound (for example, polymer), but is preferably a polymer. When the compound having a cage structure is a polymer, its weight average molecular weight is preferably from 1000 to 500000, more preferably from 5000 to 200000, especially preferably from 10000 to 100000. The polymer having a cage structure may be contained, as a resin composition having a molecular weight distribution, in a coating solution for forming a film. When the compound having a cage structure is a low molecular compound, its molecular weight is preferably from 150 to 3000, more preferably from 200 to 2000, especially preferably from 220 to 1000.

As the solvent used in the polymerization reaction, any solvent is usable insofar as it can dissolve a raw material monomer therein at a required concentration and has no adverse effect on the properties of a film formed from the polymer. Examples include water, alcohol solvents such as methanol, ethanol and propanol, ketone solvents such as alcohol acetone, methyl ethyl ketone, methyl isobutyl ketone, cyclohexanone and acetophenone; ester solvents such as ethyl acetate, butyl acetate, propylene glycol monomethyl ether acetate, y-butyrolactone and methyl benzoate; ether solvents such as dibutyl ether and anisole; aromatic hydrocarbon solvents such as toluene, xylene, mesitylene, 1,2,4,5-tetramethylbenzene, pentamethylbenzene, isopropylbenzene, 1,4-diisopropylbenzene, t-butylbenzene, 1,4-di-t-butylbenzene, 1,3,5-triethylbenzene, 1,3,5-tri-t-butylbenzene, 4-t-butyl-orthoxylene, 1-methylnaphthalene and 1,3,5-triisopropylbenzene; amide solvents such as N-methylpyrrolidinone and dimethylacetamide; halogen solvents such as carbon tetrachloride, dichloromethane, chloroform, 1,2-dichloroethane, chlorobenzene, 1,2-dichlorobenzene and 1,2,4-trichlorobenzene; and aliphatic hydrocarbon solvents such as hexane, heptane, octane and cyclohexane.

Of these solvents, more preferred are acetone, methyl ethyl ketone, methyl ethyl ketone, methyl isobutyl ketone, cyclohexanone, acetophenone, ethyl acetate, propylene glycol monomethyl ether acetate, γ-butyrolactone, anisole, tetrahydrofuran, toluene, xylene, mesitylene, 1,2,4,5-tetramethylbenzene, isopropylbenzene, t-butylbenzene, 1,4-di-t-butylbenzene, 1,3,5-tri-t-butylbenzene, 4-t-butyl-orthoxylene, 1-methylnaphthalene, 1,3,5-triisopropylbenzene, 1,2-dichloroethane, chlorobenzene, 1,2-dichlorobenzene and 1,2,4-trichlorobenzene, of which tetrahydrofuran, γ-butyrolactone, anisole, toluene, xylene, mesitylene, isopropylbenzene, t-butylbenzene, 1,3,5-tri-t-butylbenzene, 1-methylnaphthalene, 1,3,5-triisopropylbenzene, 1,2-dichloroethane, chlorobenzene, 1,2-dichlorobenzene and 1,2,4-trichlorobenzene are still more preferred and γ-butyrolactone, anisole, mesitylene, t-butylbenzene, 1,3,5-triisopropylbenzene, 1,2-dichlorobenzene and 1,2,4-trichlorobenzene are especially preferred. These solvents may be used either singly or in combination.

The monomer concentration in the reaction mixture is preferably from 1 to 50 mass %, more preferably from 5 to 30 mass %, especially preferably from 10 to 20 mass %.

The conditions most suited for the polymerization reaction in the invention differ, depending on the kind or concentration of the polymerization initiator, monomer or solvent. The polymerization reaction is performed preferably at an inner temperature of from 0 to 200° C., more preferably from 50 to 170° C., especially preferably from 100 to 150° C., preferably for 1 to 50 hours, more preferably from 2 to 20 hours, especially preferably from 3 to 10 hours.

To suppress the inactivation of the polymerization initiator which will otherwise occur by oxygen, the reaction is performed preferably in an inert gas atmosphere (for example, nitrogen or argon). The oxygen concentration upon reaction is preferably 100 ppm or less, more preferably 50 ppm or less, especially preferably 20 ppm or less.

The polymer obtained by polymerization has a mass average molecular weight of preferably from 1000 to 500000, more preferably from 5000 to 300000, especially preferably from 10000 to 200000.

The compounds of the invention having a cage structure preferably have sufficient solubility in an organic solvent. The solubility at 25° C. in cyclohexanone or anisole is preferably 3 mass % or greater, more preferably 5 mass % or greater, especially preferably 10 mass % or greater.

Examples of the compound of the invention having a cage structure include polybenzoxazoles as described in JP-A-11-322929, JP-A-2003-12802, and JP-A-2004-18593, quinoline resins as described in JP-A-2001-2899, polyaryl resins as described in JP-T-2003-530464 (the term “JP-T” as used herein means a published Japanese translation of a PCT patent application), JP-T-2004-535497, JP-T-2004-504424, JP-T-2004-504455, JP-T-2005-501131, JP-T-2005-516382, JP-T-2005-514479, JP-T-2005-522528, JP-A-2000-100808 and U.S. Pat. No. 6,509,415, polyadamantanes as described in JP-A-11-214382, JP-A-2001-332542, JP-A-2003-252982, JP-A-2003-292878, JP-A-2004-2787, JP-A-2004-67877 and JP-A-2004-59444, and polyimides as described in JP-A-2003-252992 and JP-A-2004-26850.

In the invention, the above-described polymers may be used either singly or in combination.

The polymer of the compound to be used in the invention is preferably a compound other than polyimide, that is, a compound having no polyimide bond from the standpoints of dielectric constant and absorption of film.

The film forming composition of the invention containing, in addition to the compound having a cage structure, an organic solvent as a coating solvent can be provided as a preferable coating solution.

There is no particular limitation imposed on the organic solvent to be used in the invention insofar as it can dissolve therein the compound having a cage structure which is used in the invention. Examples include alcohol solvents such as methanol, ethanol, 2-propanol, 1-butanol, 2-ethoxymethanol, 3-methoxypropanol and 1-methoxy-2-propanol; ketone solvents such as acetone, acetylacetone, methyl ethyl ketone, methyl isobutyl ketone, 2-pentanone, 3-pentanone, 2-heptanone, 3-heptanone, cyclopentanone and cyclohexanone; ester solvents such as ethyl acetate, propyl acetate, butyl acetate, isobutyl acetate, pentyl acetate, ethyl propionate, propyl propionate, butyl propionate, isobutyl propionate, propylene glycol monomethyl ether acetate, methyl lactate, ethyl lactate and γ-butyrolactone; ether solvents such as diisopropyl ether, dibutyl ether, ethyl propyl ether, anisole, phenetole and veratrole; aromatic hydrocarbon solvents such as mesitylene, ethylbenzene, diethylbenzene, propylbenzene and t-butylbenzene; and amide solvents such as N-methylpyrrolidinone and dimethylacetamide. These solvents may be used either singly or in combination.

Of these, more preferred organic solvents are 1-methoxy-2-propanol, propanol, acetylacetone, cyclohexanone, propylene glycol monomethyl ether acetate, butyl acetate, methyl lactate, ethyl lactate, γ-butyrolactone, anisole, mesitylene, and t-butylbenzene, with 1-methoxy-2-propanol, cyclohexanone, propylene glycol monomethyl ether acetate, ethyl lactate, γ-butyrolactone, t-butylbenzene and anisole being especially preferred.

The solid concentration of the film forming composition of the invention is preferably from 1 to 50 mass %, more preferably from 2 to 15 mass %, especially preferably from 3 to 10 mass %.

The content of metals, as an impurity, of the film forming composition of the invention is preferably as small as possible. The metal content of the film forming composition can be measured with high sensitivity by the ICP-MS and in this case, the content of metals other than transition metals is preferably 30 ppm or less, more preferably 3 ppm or less, especially preferably 300 ppb or less. The content of the transition metal is preferably as small as possible because it accelerates oxidation by its high catalytic capacity and the oxidation reaction in the prebaking or thermosetting process decreases the dielectric constant of the film obtained by the invention. The metal content is preferably 10 ppm or less, more preferably 1 ppm or less, especially preferably 100 ppb or less.

The metal concentration of the film forming composition can also be evaluated by subjecting a film obtained using the film forming composition of the invention to total reflection fluorescent X-ray analysis. When W ray is employed as an X-ray source, the metal concentrations of metal elements such as K, Ca, Ti, Cr, Mn, Fe, Co, Ni, Cu, Zn, and Pd can be measured. The concentrations of them are each preferably from 100×10¹⁰ atom·cm⁻² or less, more preferably 50×10¹⁰ atom·cm⁻² or less, especially preferably 10×10 atom·cm⁻² or less. In addition, the concentration of Br as a halogen can be measured. Its remaining amount is preferably 10000×10¹⁰ atom·cm⁻² or less, more preferably 1000×10¹⁰ atom·cm⁻², especially preferably 400×10¹⁰ atom·cm⁻². Moreover, the concentration of Cl can also be observed as a halogen. In order to prevent it from damaging a CVD device, etching device or the like, its remaining amount is preferably 100×10¹⁰ atom·cm⁻² or less, more preferably 50×10¹⁰ atom·cm⁻², especially preferably 10×10¹⁰ atom·cm⁻² .

To the film forming composition of the invention, additives such as radical generator, colloidal silica, surfactant, silane coupling agent and adhesive agent may be added without impairing the properties (such as heat resistance, dielectric constant, mechanical strength, coatability, and adhesion) of an insulating film obtained using it.

Any colloidal silica may be used in the invention. For example, a dispersion obtained by dispersing high-purity silicic anhydride in a hydrophilic organic solvent or water and having usually an average particle size of from 5 to 30 nm, preferably from 10 to 20 nm and a solid concentration of from about 5 to 40 mass % can be used.

Any surfactant may be added in the invention. Examples include nonionic surfactants, anionic surfactants and cationic surfactants. Further examples include silicone surfactants, fluorosurfactants, polyalkylene oxide surfactants, and acrylic surfactants. In the invention, these surfactants can be used either singly or in combination. As the surfactant, silicone surfactants, nonionic surfactants, fluorosurfactants and acrylic surfactants are preferred, with silicone surfactants being especially preferred.

The amount of the surfactant to be used in the invention is preferably from 0.01 mass % or greater but not greater than 1 mass %, more preferably from 0.1 mass % or greater but not greater than 0.5 mass % based on the total amount of the film forming coating solution.

The term “silicone surfactant” as used herein means a surfactant containing at least one Si atom. Any silicone surfactant may be used in the invention, but it preferably has a structure containing an alkylene oxide and dimethylsiloxane, of which a silicone surfactant having a compound represented by the following formula is more preferred:

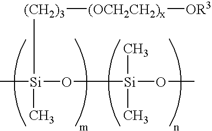

In the above formula, R³ represents a hydrogen atom or a C₁₋₅ alkyl group, x stands for an integer of from 1 to 20, and m and n each independently represents an integer of from 2 to 100. A plurality of R³s may be the same or different.

Examples of the silicone surfactant to be used in the invention include “BYK 306”, “BYK 307” (each, trade name; product of BYK Chemie), “SH7PA”, “SH21PA”, “SH28PA”, and “SH30PA” (each, trade name; product of Dow Coming Toray Silicone) and Troysol S366 (trade name; product of Troy Chemical).

As the nonionic surfactant to be used in the invention, any nonionic surfactant is usable. Examples include polyoxyethylene alkyl ethers, polyoxyethylene aryl ethers, polyoxyethylene dialkyl esters, sorbitan fatty acid esters, fatty-acid-modified polyoxyethylenes, and polyoxyethylene-polyoxypropylene block copolymers.

As the fluorosurfactant to be used in the invention, any fluorosurfactant is usable. Examples include perfluorooctyl polyethylene oxide, perfluorodecyl polyethylene oxide and perfluorododecyl polyethylene oxide.

As the acrylic surfactant to be used in the invention, any acrylic surfactant is usable. Examples include (meth)acrylic acid copolymer.

Any silane coupling agent may be used in the invention. Examples include 3-glycidyloxypropyltrimethoxysilane, 3-aminoglycidyloxypropyltriethoxysilane, 3-methacryloxypropyltrimethoxysilane, 3-glycidyloxypropylmethyldimethoxysilane, 1-methacryloxypropylmethyldimethoxysilane, 3-aminopropyltrimethoxysilane, 3-aminopropyltriethoxysilane, 2-aminopropyltrimethoxysilane, 2-aminopropyltriethoxysilane, N-(2-aminoethyl)-3-aminopropyltrimethoxysilane, N-(2-aminoethyl)-3-aminopropylmethyldimethoxysilane, 3-ureidopropyltrimethoxysilane, 3-ureidopropyltriethoxysilane, N-ethoxycarbonyl-3-aminopropyltrimethoxysilane, N-ethoxycarbonyl-3-aminopropyltriethoxysilane, N-triethoxysilylpropyltriethylenetriamine, N-triethoxysilylpropyltriethylenetriamine, 10-trimethoxysilyl-1,4,7-triazadecane, 10-triethoxysilyl-1,4,7-triazadecane, 9-trimethoxysilyl-3,6-diazanonyl acetate, 9-triethoxysilyl-3,6-diazanonyl acetate, N-benzyl-3-aminopropyltrimethoxysilane, N-benzyl-3-aminopropyltriethoxysilane, N-phenyl-3-aminopropyltrimethoxysilane, N-phenyl-3-aminopropyltriethoxysilane, N-bis(oxyethylene)-3-aminopropyltrimethoxysilane, and N-bis(oxyethylene)-3-aminopropyltriethoxysilane. Those silane coupling agents may be used either singly or in combination. The silane coupling agent may be added preferably in an amount of 10 parts by weight or less, especially preferably from 0.05 to 5 parts by weight based on 100 parts by weight of the whole solid content.

In the invention, any adhesion accelerator may be used. Examples include trimethoxysilylbenzoic acid, γ-methacryloxypropyltrimethoxysilane, vinyltriacetoxysilane, vinyltrimethoxysilane, γ-isocyanatopropyltriethoxysilane, γ-glycidoxypropyltrimethoxysilane, β-(3,4-epoxycyclohexyl)ethyltrimethoxysilane, trimethoxyvinylsilane, γ-aminopropyltriethoxysilane, aluminum monoethylacetoacetate disopropylate, vinyltris(2-methoxyethoxy)silane, N-(2-aminoethyl)-3-aminopropylmethyldimethoxysilane, N-(2-aminoethyl)-3-aminopropyltrimethoxysilane, 3-chloropropylmethyldimethoxysilane, 3-chloropropyltrimethoxysilane, 3-methacryloxypropyltrimethoxysilane, 3-mercaptopropyltrimethoxysilane, trimethylchlorosilane, dimethylvinylchlorosilane, methyldiphenylchlorosilane, chloromethyldimethylchlorosilane, trimethylmethoxysilane, dimethyldiethoxysilane, methyldimethoxysilane, dimethylvinylethoxysilane, diphenyldimethoxysilane, phenyltriethoxysilane, hexamethyldisilazane, N,N′-bis(trimethylsilyl)urea, dimethyltrimethylsilylamine, trimethylsilylimidazole, vinyltrichlorosilane, benzotriazole, benzimidazole, indazole, imidazole, 2-mercaptobenzimidazole, 2-mercaptobenzothiazole, 2-mercaptobenzoxazole, urazole, thiourasil, mercaptoimidazole, mercaptopyrimidine, 1,1-dimethylurea, 1,3-dimethylurea and thiourea compounds. A functional silane coupling agent is preferred as an adhesion accelerator. The amount of the adhesion accelerator is preferably 10 parts by weight or less, especially preferably from 0.05 to 5 parts by weight, based on 100 parts by weight of the total solid content.

It is also possible to form a porous film by adding a pore forming factor to the extent permitted by the mechanical strength of the film and thereby reducing the dielectric constant of the film.

Although no particular limitation is imposed on the pore forming factor as an additive to serve as a pore forming agent, a non-metallic compound is preferred. The pore forming agent must satisfy both the solubility in a solvent to be used for a film forming coating solution and compatibility with the polymer of the invention. The boiling point or decomposition point of the pore forming agent is preferably from 100 to 500° C., more preferably from 200 to 450° C., especially preferably from 250 to 400° C. The molecular weight of it is preferably from 200 to 50000, more preferably from 300 to 10000, especially preferably from 400 to 5000. The amount of it in terms of mass % is preferably from 0.5 to 75%, more preferably from 0.5 to 30%, especially preferably from 1 to 20% relative to the polymer for forming a film. The polymer may contain a decomposable group as the pore forming factor. The decomposition point of it is preferably from 100 to 500° C., more preferably from 200 to 450° C., especially preferably from 250 to 400° C. The content of the decomposable group is, in terms of mole %, from 0.5 to 75%, more preferably from 0.5 to 30%, especially preferably from 1 to 20% relative to the monomer amount of the polymer for forming the film.

The film can be formed by applying the film forming composition of the invention onto a substrate by a desired method such as spin coating, roller coating, dip coating or scan coating, and then heating the substrate to remove the solvent. For drying off the solvent, the substrate is heated preferably for 0.1 to 10 minutes at from 40 to 250° C.

As the method of applying the composition to the substrate, spin coating and scan coating are preferred, with spin coating being especially preferred. For spin coating, commercially available apparatuses such as “Clean Track Series” (trade name; product of Tokyo Electron), “D-spin Series” (trade name; product of Dainippon Screen), or “SS series” or “CS series” (each, trade name; product of Tokyo Oka Kogyo) are preferably employed. The spin coating may be performed at any rotation speed, but from the viewpoint of in-plane uniformity of the film, a rotation speed of about 1300 rpm is preferred for a 300-mm silicon substrate.

When the solution of the composition is discharged, either dynamic discharge in which the solution is discharged onto a rotating substrate or static discharge in which the solution is discharged onto a static substrate may be employed. The dynamic discharge is however preferred in view of the in-plane uniformity of the film. Alternatively, from the viewpoint of reducing the consumption amount of the composition, a method of discharging only a main solvent of the composition to a substrate in advance to form a liquid film and then discharging the composition thereon can be employed. Although no particular limitation is imposed on the spin coating time, it is preferably within 180 seconds from the viewpoint of throughput. From the viewpoint of the transport of the substrate, it is preferred to subject the substrate to processing (such as edge rinse or back rinse) for preventing the film from remaining at the edge portion of the substrate. The heat treatment method is not particularly limited, but ordinarily employed methods such as hot plate heating, heating with a furnace, heating in an RTP (Rapid Thermal Processor) to expose the substrate to light of, for example, a xenon lamp can be employed. Of these, hot plate heating or heating with a furnace is preferred. As the hot plate, a commercially available one, for example, “Clean Track Series” (trade name; product of Tokyo Electron), “D-spin Series” (trade name; product of Dainippon Screen) and “SS series” or “CS series” (trade name; product of Tokyo Oka Kogyo) is preferred, while as the furnace, “α series” (trade name; product of Tokyo Electron) is preferred.

It is especially preferred to apply the polymer of the invention onto a substrate and then heating to cure it. For this purpose, the polymerization reaction, at the time of post heating, of a carbon-carbon double bond or a carbon-carbon triple bond remaining in the polymer may be utilized. The post heat treatment is performed preferably at from 100 to 450° C., more preferably at from 200 to 420° C., especially preferably at from 350 to 400° C., preferably for from 1 minute to 2 hours, more preferably for from 10 minutes to 1.5 hours, especially preferably for from 30 minutes to 1 hour. The post heat treatment may be performed in several times. This post heat treatment is performed especially preferably in a nitrogen atmosphere in order to prevent thermal oxidation due to oxygen.

In the invention, the polymer may be cured not by heat treatment but by exposure to high energy radiation to cause polymerization reaction of a carbon-carbon double bond or carbon-carbon triple bond remaining in the polymer. Examples of the high energy radiation include electron beam, ultraviolet ray and X ray. The curing method is not particularly limited to these methods.

When electron beam is employed as high energy radiation, the energy is preferably from 0 to 50 keV, more preferably from 0 to 30 keV, especially preferably from 0 to 20 keV. Total dose of electron beam is preferably from 0 to 5 μC/cm² or less, more preferably from 0 to 2 μC/cm², especially preferably from 0 to 1 μC/cm² or less. The substrate temperature when it is exposed to electron beam is preferably from 0 to 450° C., more preferably from 0 to 400° C., especially preferably from 0 to 350° C. Pressure is preferably from 0 to 133 kPa, more preferably from.0 to 60 kPa, especially preferably from 0 to 20 kPa. The atmosphere around the substrate is preferably an atmosphere of an inert gas such as Ar, He or nitrogen from the viewpoint of preventing oxidation of the polymer of the invention. An oxygen, hydrocarbon or ammonia gas may be added for the purpose of causing reaction with plasma, electromagnetic wave or chemical species which is generated by the interaction with electron beam. In the invention, exposure to electron beam may be carried out in plural times. In this case, the exposure to electron beam is not necessarily carried out under the same conditions but the conditions may be changed every time.

Ultraviolet ray may be employed as high energy radiation. The radiation wavelength range of the ultraviolet ray is preferably from 190 to 400 nm, while its output immediately above the substrate is preferably from 0.1 to 2000 mWcm⁻². The substrate temperature upon exposure to ultraviolet ray is preferably from 250 to 450° C., more preferably from 250 to 400° C., especially preferably from 250 to 350° C. The atmosphere around the substrate is preferably an atmosphere of an inert gas such as Ar, He or nitrogen from the viewpoint of preventing oxidation of the polymer of the invention. The pressure at this time is preferably from 0 to 133 kPa.

When the film obtained using the film forming composition of the invention is used as an interlayer insulating film for semiconductor, a barrier layer for preventing metal migration may be disposed on the side of an interconnect. In addition, a cap layer, an interlayer adhesion layer or etching stopping layer may be disposed on the upper or bottom surface of the interconnect or interlayer insulating film to prevent exfoliation at the time of CMP (Chemical Mechanical Polishing). Moreover, the layer of an interlayer insulating film may be composed of plural layers using another material as needed.

The film obtained using the film forming composition of the invention can be etched for copper interconnection or another purpose. Either wet etching or dry etching can be employed, but dry etching is preferred. For dry etching, either ammonia plasma or fluorocarbon plasma can be used as needed. For the plasma, not only Ar but also a gas such as oxygen, nitrogen, hydrogen or helium can be used. Etching may be followed by ashing for the purpose of removing a photoresist or the like used for etching. Moreover, the ashing residue may be removed by washing.

The film obtained using the film forming composition of the invention may be subjected to CMP for planarizing the copper plated portion after copper interconnection. As a CMP slurry (chemical solution), a commercially available one (for example, product of Fujimi Incorporated, Rodel Nitta, JSR or Hitachi Chemical) can be used as needed. As a CMP apparatus, a commercially available one (for example, product of Applied Material or Ebara Corporation) can be used as needed. After CMP, the film can be washed in order to remove the slurry residue.

The film available using the film forming composition of the invention can be used for various purposes. For example, it is suited as an insulating film for semiconductor devices such as LSI, system LSI, DRAM, SDRAM, RDRAM, and D-RDRAM, and for electronic parts such as multi-chip module multilayered wiring boards. More specifically, it is usable as an interlayer insulating film for semiconductor, etching stopper film, surface protective film, and buffer coat film and in addition, as a passivation film in LSI, a-ray block film, cover lay film in flexographic plates, overcoat film, cover coat for flexible copper-lined plates, solder resist film, and liquid-crystal alignment film.

As another purpose, the film of the invention can be used as a conductive film after doping thereinto an electron donor or acceptor, thereby imparting it with conductivity.

### EXAMPLES

The present invention will next be described by the following Examples, but the scope of it is not limited by them.

### Example 1

In accordance with the synthesis process as described in Macromolecules, 24, 5266(1991), 4,9-diethynyldiamantane was synthesized. Under a nitrogen gas stream, 2 g of the resulting 4,9-diethynyldiamantane, 0.4 g of dicumyl peroxide (“PERCUMYL D”, trade name; product of NOF) and 10 ml of orthodichlorobenzene were polymerized by stirring for 5 hours at an internal temperature of 140° C. After the reaction mixture was cooled to room temperature, 100 ml of methanol was added. The solid thus precipitated was collected by filtration and washed with methanol, whereby 1.0 g of Polymer (A) having a mass-average molecular weight of about 14000 was obtained.

The solubility of Polymer (A) in cyclohexanone was 20 mass % or greater at 25° C.

A coating solution was prepared by completely dissolving 0.99 g of Polymer (A) and 0.01 g of tetrakis[methylene-3-(3,5-di-t-butyl-4-hydroxyphenyl)propionate]methane in 10 g of cyclohexanone. The resulting solution was filtered through a 0.1 μm filter made of tetrafluoroethylene, followed by spin coating on a silicon wafer. The film was heated at 250° C. for 60 seconds on a hot plate in a nitrogen gas stream and then baked for 60 minutes in an oven of 400 ° C. purged with nitrogen, whereby a 0.5-μm thick uniform film without blisters was obtained. This film was stored for 24 hours in a thermo-hygrostat of 45° C. and 90% RH, followed by exposure to the atmosphere for 1 minute at 200° C. The relative dielectric constant of the film was calculated from the capacity value measured at 1 MHz by using a mercury probe manufactured by Four Dimensions and an LCR meter HP4285A manufactured by Yokogawa Hewlett-Packard. As a result, it was found to be 2.42. No peak derived from oxidation was observed in the FT-IR spectrum.

### Example 2

In a similar manner to Example 1 except for the use of 1,1,3-tris(2-methyl-4-hydroxy-5-t-butylphenyl)butane instead of tetrakis[methylene-3-(3,5-di-t-butyl-4-hydroxyphenyl)propionate]methane, a coating solution was prepared and a film was formed. As a result, a uniform 0.5-μm film without blisters was obtained. This film was stored for 24 hours in a thermo-hygrostat of 45° C. and 90% RH, followed by exposure to the atmosphere for 1 minute at 200° C. The relative dielectric constant of the film was calculated from the capacity value measured at 1 MHz by using a mercury probe manufactured by Four Dimensions and an LCR meter HP4285A manufactured by Yokogawa Hewlett-Packard. As a result, it was found to be 2.43. No peak derived from oxidation was observed in the FT-IR spectrum.

### Example 3

In accordance with the process as described in the literature (Journal of Polymer Science: Part A: Polymer Chemistry, Vol. 30, 1747-1754(1992)), 3,3′-diethynyl-1,1′-biadamantane was synthesized. In a similar manner to Example 1 except for the use of 3,3′-diethynyl-1,1′-biadamantane instead of 4,9-diethynyldiamantane, a coating solution was prepared and a film was formed. As a result, a uniform 0.5-μm thick film having no blisters was obtained. This film was stored for 24 hours in a thermo-hygrostat of 45° C. and 90% RH, followed by exposure to the atmosphere for 1 minute at 200° C. The relative dielectric constant of the film was calculated from the capacity value measured at 1 MHz by using a mercury probe manufactured by Four Dimensions and an LCR meter HP4285A manufactured by Yokogawa Hewlett-Packard. As a result, it was found to be 2.42. No peak derived from oxidation was observed in the FT-IR spectrum.

### Example 4

In accordance with the synthesis process as described in Macromolecules, 5266(1991), 4,9-diethynyldiamantane was synthesized. Under a nitrogen gas stream, 2 g of the resulting 4,9-diethynyldiamantane, 0.4 g of dicumyl peroxide (“PERCUMYL D”, trade name; product of NOF) and 10 ml of orthodichlorobenzene were polymerized by stirring for 5 hours at an internal temperature of 140° C. After the reaction mixture was cooled to room temperature, 100 ml of methanol was added. The solid thus precipitated was collected by filtration and washed with methanol, whereby 1.0 g of Polymer (A) having a mass-average molecular weight of about 14000 was obtained.

A coating solution was then prepared by completely dissolving 0.99 g of the resulting composition and 0.01 g of“ADK STAB AO-60” (tetrakis[methylene-3-(3,5-di-t-butyl-4-hydroxyphenyl)propionate]methane) of ADEKA in 10 g of cyclohexanone. The resulting solution was filtered through a 0.1 μm filter made of tetrafluoroethylene, followed by spin coating on a silicon wafer. The film was heated at 200° C. for 60 seconds on a hot plate in a nitrogen gas stream and then baked for 60 minutes in an oven of 400° C. purged with nitrogen, whereby a 0.5-μm thick uniform film without blisters was obtained. This film was stored for 24 hours in a thermo-hygrostat of 45° C. and 90% RH, followed by exposure to the atmosphere for 1 minute at 200° C. The relative dielectric constant of the film was calculated from the capacity value measured at 1 MHz by using a mercury probe manufactured by Four Dimensions and an LCR meter HP4285A manufactured by Yokogawa Hewlett-Packard. As a result, it was found to be 2.42, though the relative dielectric constant just after film formation was 2.4 1. This has revealed that there occurred no change in a relative dielectric constant even under oxidation promotion conditions. In addition, no peak derived from the oxidation was observed in the FT-IR spectrum.

### Example 5

In a similar manner to Example 4 except for the use of bis-(2,2,6,6-tetramethyl-4-piperidinyl)sebacate (product of Aldrich) instead of “ADK STAB AO-60”, a coating solution was prepared and a film was formed. As a result, a uniform 0.5-μm thick film without blisters was obtained. The resulting film was stored for 24 hours in a thermo-hygrostat of 45° C. and 90% RH, followed by exposure to the atmosphere for I minute at 200° C. The relative dielectric constant of the film was calculated from the capacity value measured at 1 MHz by using a mercury probe manufactured by Four Dimensions and an LCR meter HP4285A manufactured by Yokogawa Hewlett-Packard. It was found to be 2.43, though the relative dielectric constant just after film formation was 2.41. This has revealed that there occurred no change in a relative dielectric constant even under oxidation promotion conditions. In addition, no peak derived from the oxidation was observed in the FT-IR spectrum.

### Example 6

In a similar manner to Example 4 except for the use of “ADK STAB LA-52” (trade name of tetrakis(1,2,2,6,6-pentamethyl-4-piperidinyl)-1,2,3,4-butanetetracarboxylate) instead of “ADK STAB AO-60”, a coating solution was prepared and a film was formed. As a result, a uniform 0.5-μm thick film without blisters was obtained. The resulting film was stored for 24 hours in a thermo-hygrostat of 45° C. and 90% RH, followed by exposure to the atmosphere for 1 minute at 200° C. The relative dielectric constant of the film was calculated from the capacity value measured at 1 MHz by using a mercury probe manufactured by Four Dimensions and an LCR meter HP4285A manufactured by Yokogawa Hewlett-Packard. As a result, it was found to be 2.41, though the relative dielectric constant just after film formation was 2.41. This has revealed that there occurred no change in a relative dielectric constant even under oxidation promotion conditions. In addition, no peak derived from the oxidation was observed in the FT-IR spectrum.

### Example 7

In a similar manner to Example 4 except for the use of “ADK STAB LA-57” (trade name of tetrakis(2,2,6,6-tetramethyl-4-piperidinyl)-1,2,3,4-butanetetracarboxylate)) instead of “ADK STAB AO-60”, a coating solution was prepared and a film was formed. As a result, a uniform 0.5-μm thick film without blisters was obtained. The resulting film was stored for 24 hours in a thermo-hygrostat of 45° C. and 90% RH, followed by exposure to the atmosphere for 1 minute at 200° C. The relative dielectric constant of the film was calculated from the capacity value measured at 1 MHz by using a mercury probe manufactured by Four Dimensions and an LCR meter HP4285A manufactured by Yokogawa Hewlett-Packard. As a result, it was found to be 2.42, though the relative dielectric constant just after film formation was 2.41. This has revealed that there occurred no change in a relative dielectric constant even under oxidation promotion conditions. In addition, no peak derived from the oxidation was observed in the FT-IR spectrum.

### Comparative Example 1

In a similar manner to Example 1 except that tetrakis[methylene-3-(3,5-di-t-butyl-4-hydroxypehnyl)propionate]methane was not added, a coating solution was prepared and a film was formed. As a result, a uniform 0.5-μm thick film without blisters was obtained. The resulting film was stored for 24 hours in a thermo-hygrostat of 45° C. and 90% RH, followed by exposure to the atmosphere for 1 minute at 200° C. The relative dielectric constant of the film was calculated from the capacity value measured at 1 MHz by using a mercury probe manufactured by Four Dimensions and an LCR meter HP4285A manufactured by Yokogawa Hewlett-Packard. As a result, it was found to be 2.55. A peak derived from the oxidation was observed in the FT-IR spectrum.

### Comparative Example 2

In a similar manner to Example 4 except that ADK STAB AO-60 was not added, a coating solution was prepared and a film was formed. As a result, a uniform 0.5-μm thick film without blisters was obtained. The resulting film was stored for 24 hours in a thermo-hygrostat of 45° C. and 90% RH, followed by exposure to the atmosphere for 1 minute at 200° C. The relative dielectric constant of the film was calculated from the capacity value measured at 1 MHz by using a mercury probe manufactured by Four Dimensions and an LCR meter HP4285A manufactured by Yokogawa Hewlett-Packard. As a result, the specific dielectric constant was found to be 2.62, though it was 2.41 just after the film formation. This has revealed that there occurred a change in specific dielectric constant depending on the oxidation promotion conditions. A peak derived from the oxidation was observed clearly in the FT-IR spectrum.

According to the present invention, an insulating film suited for use as an interlayer insulating film in semiconductors or the like and having a low relative dielectric constant and heat resistance can be formed. In particular, an insulating film having a low relative dielectric constant even if stored under high humidity conditions after the film formation can be formed.

The entire disclosure of each and every foreign patent application from which the benefit of foreign priority has been claimed in the present application is incorporated herein by reference, as if fully set forth.

What is claimed is:

1. A film forming composition comprising:
a compound having a cage structure; and
an antioxidant.

2. The film forming composition according to claim 1,
wherein the antioxidant is a phenolic antioxidant.

3. The film forming composition according to claim 1,
wherein the antioxidant is a hindered amine antioxidant.

4. The film forming composition according to claim 1,
wherein the compound having the cage structure is a polymer of a monomer having a cage structure.

5. The film forming composition according to claim 4,
wherein the monomer having the cage structure has a carbon-carbon double bond or a carbon-carbon triple bond.

6. The film forming composition according to claim 1,
wherein the cage structure is selected from the group consisting of adamantane, biadamantane, diamantane, triamantane and tetramantane.

7. The film forming composition according to claim 4,
wherein the monomer having the cage structure is a compound represented by any one of formulas (I) to (VI): 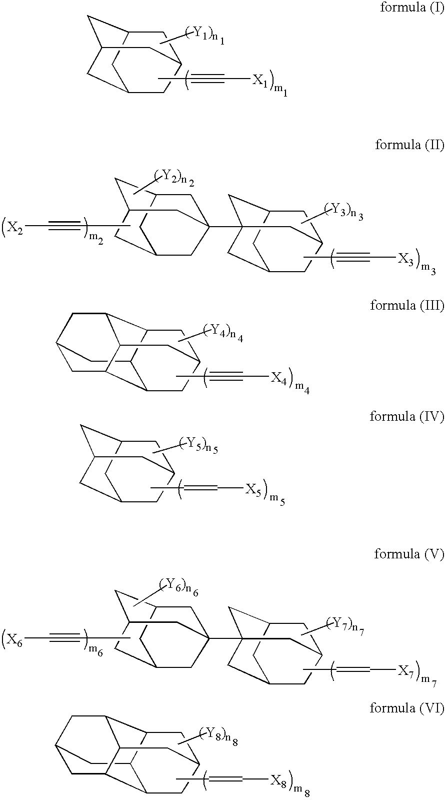
wherein X₁ to X₈ each independently represents an atom or group selected from the group consisting of a hydrogen atom, an alkyl group, an alkenyl group, an alkynyl group, an aryl group, a silyl group, an acyl group, an alkoxycarbonyl group and a carbamoyl group;
Y₁ to Y₈ each independently represents an atom or group selected from the group consisting of a halogen atom, an alkyl group, an aryl group and a silyl group;
m₁ and m₅ each independently represents an integer of from 1 to 16;
n₁ and n₅ each independently represents an integer of from 0 to 15;
m₂, m₃, m₆ and m₇ each independently represents an integer of from 1 to 15;
n₂, n₃, n₆ and n₇ each independently represents an integer of from 0 to 14;
m₄ and m₈ each independently represents an integer of from 1 to 20; and
n₄ and n₈ each independently represents an integer of from 0 to 19.

8. The film forming composition according to claim 1,
wherein the compound having the cage structure is obtained by polymerizing the monomer having the cage structure in the presence of a transition metal catalyst or a radical initiator.

9. The film forming composition according to claim 1,
wherein the compound having the cage structure has a solubility at 25° C. of 3 mass % or greater in cyclohexanone or anisole.

10. The film forming composition according to claim 1, further comprising an organic solvent.

11. An insulating film formed by using the film forming composition according to claim 1.

12. An electronic device comprising the insulating film according to claim 11.
